(19) United States
(12) Patent Application Publication
(10) Pub. No.: US 2014/0176846 A1
(43) Pub. Date: Jun. 26, 2014

(54) LIQUID CRYSTAL MODULE AND STEPPED FRAME STRUCTURE THEREOF

(71) Applicants: Gang Yu, Guangdong (CN); Pei Jia, Guangdong (CN); Liuyang Yang, Guangdong (CN)

(72) Inventors: Gang Yu, Guangdong (CN); Pei Jia, Guangdong (CN); Liuyang Yang, Guangdong (CN)

(73) Assignee: Shenzhen China Star Optoelectronics Technology Co. Ltd., Guangdong (CN)

(21) Appl. No.: 13/703,600

(22) PCT Filed: Nov. 2, 2012
(86) PCT No.: PCT/CN2012/083979

§ 371 Date: Dec. 11, 2012

(30) Foreign Application Priority Data
Oct. 29, 2012 (CN) 201210420859.9

(51) Int. Cl. G02F 1/1333

(52) U.S. Cl. CPC G02F 1/133308
USPC 349/58

(57) ABSTRACT

The present invention discloses a liquid crystal module and a stepped frame structure thereof, which has side edges of stepped-shape having a lower half greater than an upper half thereof. The stepped frame structure has a first receiving space in the upper half thereof and a second receiving space in the lower half thereof. A liquid crystal panel disposed in the first receiving space, and a backlight module disposed in the second receiving space. In the present invention, by a stepped frame structure (30), it can simultaneously assemble and fix the backlight module and the liquid crystal panel to form the liquid crystal module by just using a single frame structure. Hence, it can simplify the frame design of the liquid crystal module, and is advantageous for a narrow frame development trend, so that it can match a corresponding outer display housing to process a without-screw-members assembly operation.

### FIELD OF THE INVENTION

The present invention relates to a liquid crystal module, and more particularly to a liquid crystal module having a stepped frame structure.

### BACKGROUND OF THE INVENTION

A liquid crystal display (LCD) is a kind of flat panel display (FPD) which displays images by the property of the liquid crystal material. In comparison with other display devices, the LCD has the advantages in lightweight, compactness, low driving voltage and low power consumption, and thus has already become the mainstream product in the whole consumer market. However, the liquid crystal material of the LCD cannot emit light by itself, and must depend upon an external light source. Thus, the LCD further has a backlight module to provide the needed light source.

Generally speaking, backlight modules have been developed based on size requirements into edge lighting type structures and bottom lighting type structures, which are categorized by locations of lamp tubes thereof. A light source of the edge lighting type structures is a single light source placed aside, and a light source of the bottom lighting type structures is placed right beneath. The lamp tubes of the backlight modules must be featured with high brightness and a long lifespan, etc., and include cold cathode fluorescent lamps (CCFL), hot cathode fluorescent lamps, light emitting diodes (LED) and electroluminescence (EL), etc. Nowadays, with the rise of environmental consciousness, because that using LEDs as backlight sources has an advantage of energy saving and environmental protection in comparison with the CCFL, it thus becomes a trend in backlight development to replace the CCFL by the LEDs. Besides, by using LEDs as a backlight source, an LCD or LCD TV is further developed toward a design direction of narrow frame.

Referring now to FIG. 1, a cross-sectional side view of a traditional liquid crystal module is illustrated in FIG. 1. Specially explaining, for conveniently describing, the contents of this figure are shown with a simple and schematic method. A traditional liquid crystal module 90 comprises a back plate 91, a light guide plate and optical film assembly 92, a plastic housing 93, a liquid crystal panel 94 and a front frame 95. The back plate 91 is used for loading light sources (not shown) and the light guide plate and optical film assembly 92; the plastic housing 93 is disposed on an outer side of the back plate 91 downward from the top, and fix the light guide plate and optical film assembly 92 to form a backlight module; the liquid crystal panel 94 is loaded on the plastic housing 93; and the front frame 95 fixes the liquid crystal panel 94 on the backlight module. However, in the design and assembly process of the whole liquid crystal module 90, because the plastic housing 93 and the front frame 95 are needed for fixing the components, respectively, it will repeat a part of functions thereof and increase assembly steps. Besides, because the structure is more complex, it is disadvantageous for a development trend that LCD is designed toward narrow frame.

Moreover, in the assembly of the liquid crystal module 90, it is necessary to use a method of screw-connection to assemble the liquid crystal module 90 or fix whole of the liquid crystal module 90 into an outer housing of an LCD. However, it will occupy an extra volume in the liquid crystal module 90 whether the screw members are disposed in a perpendicular or horizontal direction. Besides, it will increase the assembly steps, and is disadvantageous for a development trend that LCD is designed toward narrow frame.

As a result, it is necessary to provide a liquid crystal module and a stepped frame structure thereof to solve the problems existing in the conventional technologies.

### SUMMARY OF THE INVENTION

A primary object of the present invention is to provide a liquid crystal module and a stepped frame structure thereof, so as to solve the problems existing in the conventional technologies: it is necessary to have a plastic housing and a front frame for assembly of backlight module and liquid crystal module, and screw members will occupy an extra volume.

To achieve the above object, the present invention provides a liquid crystal module, which comprises:

a stepped frame structure having side edges of stepped-shape, a lower half of which is greater than an upper half thereof, wherein a first receiving space located in the upper half thereof and a second receiving space located in the lower half thereof are provided;

a liquid crystal panel disposed in the first receiving space, wherein an upper surface of the liquid crystal panel and an upper surface of the stepped frame structure are coplanar; and

a backlight module disposed in the second receiving space;

wherein the liquid crystal module is further provided with a front display frame and a back display frame; the front display frame and the back display frame commonly enclose the liquid crystal module; and the shape of an inner surface of the front display frame is corresponding to the shape of an outer surface of the stepped frame structure.

In one embodiment of the present invention, a washer is provided between the liquid crystal panel and the backlight module.

In one embodiment of the present invention, the upper surface of the stepped frame structure and an upper surface of the front display frame are coplanar.

To achieve the above object, the present invention further provides a liquid crystal module, which comprises:

a stepped frame structure having side edges of stepped-shape, a lower half of which is greater than an upper half thereof, wherein a first receiving space located in the upper half thereof and a second receiving space located in the lower half thereof are provided;

a liquid crystal panel disposed in the first receiving space; and

a backlight module disposed in the second receiving space.

In one embodiment of the present invention, a washer is provided between the liquid crystal panel and the backlight module.

In one embodiment of the present invention, an upper surface of the liquid crystal panel and an upper surface of the stepped frame structure are coplanar.

In one embodiment of the present invention, the liquid crystal module is further provided with a front display frame and a back display frame; the front display frame and the back display frame commonly enclose the liquid crystal module; and the shape of an inner surface of the front display frame is corresponding to the shape of an outer surface of the stepped frame structure.

In one embodiment of the present invention, the upper surface of the stepped frame structure and an upper surface of the front display frame are coplanar.

To achieve the above object, the present invention further provides a stepped frame structure of a liquid crystal module, which has side edges of stepped-shape, and a lower half of which is greater than an upper half thereof, wherein a first receiving space located in the upper half thereof and a second receiving space located in the lower half thereof are provided; wherein a liquid crystal panel is disposed in the first receiving space, and a backlight module is disposed in the second receiving space.

In one embodiment of the present invention, a washer is provided between the liquid crystal panel and the backlight module.

In one embodiment of the present invention, an upper surface of the liquid crystal panel and an upper surface of the stepped frame structure are coplanar.

In one embodiment of the present invention, the liquid crystal module is further provided with a front display frame and a back display frame; the front display frame and the back display frame commonly enclose the liquid crystal module; and the shape of an inner surface of the front display frame is corresponding to the shape of an outer surface of the stepped frame structure.

In one embodiment of the present invention, the upper surface of the stepped frame structure and an upper surface of the front display frame are coplanar.

In the present invention, by a stepped frame structure, it can simultaneously assemble and fix the backlight module and the liquid crystal panel to form the liquid crystal module by just using a single frame structure. Hence, it can simplify the frame design of the liquid crystal module, and is advantageous for a development trend that liquid crystal display is designed toward narrow frame, so that it can match a corresponding outer housing of display device to process an assembly operation without screw members.

### DESCRIPTION OF THE DRAWINGS

FIG. 1 is a cross-sectional side view of a traditional liquid crystal module;

FIG. 2 is a cross-sectional side view of a liquid crystal module according to a preferred embodiment of the present invention;

FIG. 3 is a partial cross-sectional side view of a stepped frame structure according to the preferred embodiment of the present invention;

FIG. 4 is a cross-sectional side view showing the liquid crystal module according to the preferred embodiment of the present invention is assembled into an outer housing of a display device; and

FIG. 5 is a partial cross-sectional side view showing a liquid crystal module according to another preferred embodiment of the present invention is assembled in an outer housing of a display device.

### DETAILED DESCRIPTION OF THE PREFERRED EMBODIMENTS

The foregoing objects, features and advantages adopted by the present invention can be best understood by Referring now to the following detailed description of the preferred embodiments and the accompanying drawings. Furthermore, the directional terms described in the present invention, such as upper, lower, front, rear, left, right, inner, outer, side and etc., are only directions Referring now to the accompanying drawings, so that the used directional terms are used to describe and understand the present invention, but the present invention is not limited thereto.

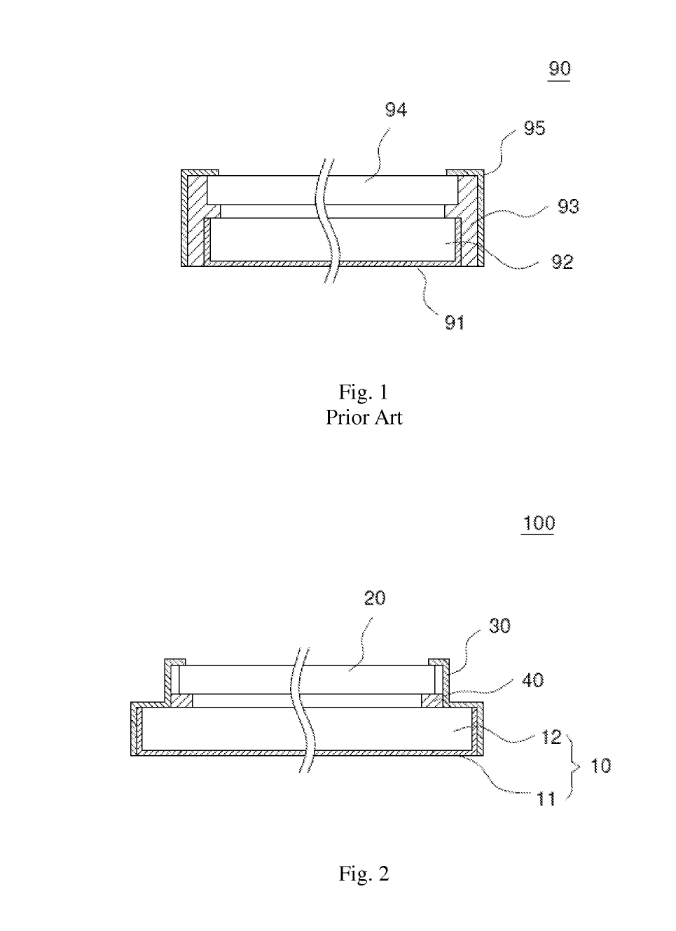

Referring now to FIG. 2, a cross-sectional side view of a liquid crystal module according to a preferred embodiment of the present invention is illustrated in FIG. 2. Specially explaining, for conveniently describing, the contents of this figure are shown with a simple and schematic method. As shown in FIG. 2, a liquid crystal module 100 according to the present invention comprises a backlight module 10, a liquid crystal panel 20 and a stepped frame structure 30, wherein the backlight module 10 and the liquid crystal panel 20 are disposed in the stepped frame structure 30.

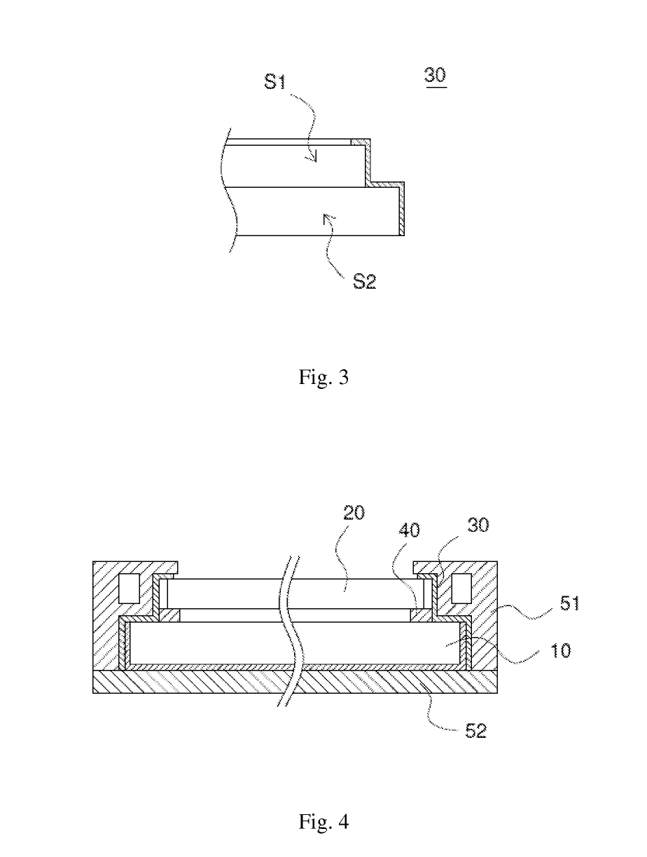

Referring now to FIG. 3, a partial cross-sectional side view of a stepped frame structure according to the preferred embodiment of the present invention is illustrated in FIG. 3. The stepped frame structure 30 has side edges of stepped-shape, a lower half of which is greater than an upper half thereof, and inside of the stepped frame structure 30, a first receiving space S1 located in the upper half thereof and a second receiving space S2 located in the lower half thereof are provided.

Referring to FIG. 2, the liquid crystal panel 20 is disposed in the first receiving space S1, and the backlight module 10 is disposed in the second receiving space S2. For detailed description, the backlight module 10 comprises at least one light source assembly (not shown), a back plate 11 and a light guide plate assembly 12 (comprising of an optical film assembly), but do not comprise a plastic housing structure which is traditionally used for fixing the light guide plate assembly 12 in the back plate. However, for conveniently describing, in the present invention, the back plate 11 and the light guide plate assembly 12 are called as the backlight module 10.

Additionally, the liquid crystal module 100 according to the present invention is mainly assembled by using the stepped frame structure 30 as an outer housing. The upper surface of the stepped frame structure 30 is provided with a display area (not indicated), and the display area is smaller than the area of the liquid crystal panel 20, so that it is able to limit and fix the liquid crystal panel 20.

Moreover, because the area of the first receiving space S1 is smaller than the area of the second receiving space S2, the assembly order of internal components of the liquid crystal module 100 according to the present invention is different from the assembly method of a traditional liquid crystal module: in the liquid crystal module 100 according to the present invention, firstly, placing the liquid crystal panel 20 into the first receiving space S1 (along the down-up direction in FIG. 2); and next, placing the backlight module 10 into the second receiving space S2 (along the down-up direction in FIG. 2).

Preferably, in a space between the backlight module 10 and the liquid crystal panel 20, it can be selectively provided with a washer 40 at the side edge thereof, so that the backlight module 10 and the liquid crystal panel 20 can keep a constant gap from each other, and it can provide a function of cushion-protection.

To compare with the traditional technology, it is necessary to have a plastic housing and a front frame for assembly of backlight module and liquid crystal module. In an assembly process of the present invention, it can simultaneously assemble and fix the backlight module 10 and the liquid crystal panel 20 to form the liquid crystal module 100 by just using a single frame structure. Hence, the present invention can simplify the frame design of the liquid crystal module 100, so it is advantageous for a development trend that liquid crystal display (LCD) is designed toward narrow frame.

Referring now to FIG. 4, a cross-sectional side view showing the liquid crystal module according to the preferred embodiment of the present invention is assembled in an outer housing of a display device is illustrated in FIG. 4. Outside the liquid crystal module 100, it is further provided with a front display frame 51 and a back display frame 52. The shape of an inner surface of the front display frame 51 is corresponding to the shape of an outer surface of the stepped frame structure 30, and the front display frame 51 and the back display frame 52 commonly enclose the liquid crystal module 100. That is to say, because the shape of the inner surface of the front display frame 51 is an inversed stepped-shape, when to assemble the front display frame 51 and the back display frame 52, it is not necessary to use extra screw members, and it can simultaneously fix the liquid crystal module 100 into the housing of the display device. Hence, in the present invention, it is not necessary to design extra screw members to fix the liquid crystal module 100, so it can reduce a volume occupied by screw members, simplify the assembly steps, and is advantageous for a development trend that LCD is designed toward narrow frame.

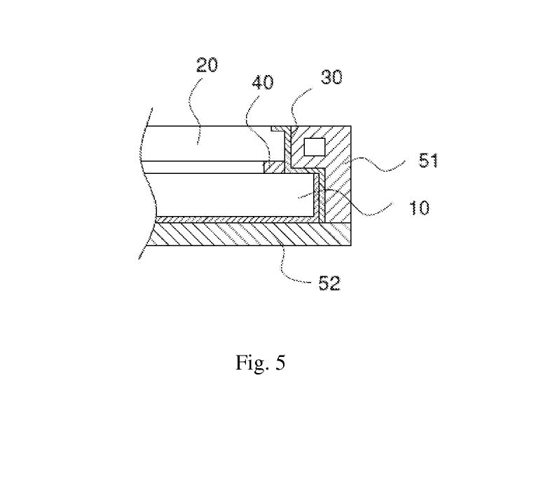

Referring now to FIG. 5, a partial cross-sectional side view showing a liquid crystal module according to another preferred embodiment of the present invention is assembled in an outer housing of a display device is illustrated in FIG. 5. This preferred embodiment is substantially similar to the preferred embodiment in FIG. 4 of the present invention, so as to use similar terms and numerals, but the difference therebetween is that: In this preferred embodiment, an upper surface of the liquid crystal panel 20 and an upper surface of the stepped frame structure 30 are coplanar (i.e. in the same plane). Furthermore, preferably, the upper surface of the stepped frame structure 30 and an upper surface of the front display frame 51 are coplanar. Hence, it is advantageous for a development trend that LCD is designed toward thin type.

As described above, to compare with the traditional technology, it is necessary using a method of screw-connection to assemble the liquid crystal module, so it will increase the assembly steps, and is disadvantageous for a development trend that LCD is designed toward narrow frame. In the present invention, by a stepped frame structure 30, it can simultaneously assemble and fix the backlight module 10 and the liquid crystal panel 20 to form the liquid crystal module 100 just using a single frame structure. Hence, it can simplify the frame design of the liquid crystal module 100, is advantageous for a development trend that LCD is designed toward narrow frame, and can match a corresponding outer housing of a display device to process an assembly operation without screw members.

The present invention has been described with a preferred embodiment thereof and it is understood that many changes and modifications to the described embodiment can be carried out without departing from the scope and the spirit of the invention that is intended to be limited only by the appended claims.

1. A liquid crystal module, comprising:
a stepped frame structure having side edges of stepped-shape, a lower half of which is greater than an upper half thereof, wherein a first receiving space located in the upper half thereof and a second receiving space located in the lower half thereof are provided;
a liquid crystal panel disposed in the first receiving space, wherein an upper surface of the liquid crystal panel and an upper surface of the stepped frame structure are coplanar; and
a backlight module disposed in the second receiving space;
wherein the liquid crystal module is further provided with a front display frame and a back display frame; the front display frame and the back display frame commonly enclose the liquid crystal module; and the shape of an inner surface of the front display frame is corresponding to the shape of an outer surface of the stepped frame structure.

2. The liquid crystal module according to claim 1, wherein a washer is provided between the liquid crystal panel and the backlight module.

3. The liquid crystal module according to claim 1, wherein the upper surface of the stepped frame structure and an upper surface of the front display frame are coplanar.

4. A liquid crystal module, comprising:
a stepped frame structure having side edges of stepped-shape, a lower half of which is greater than an upper half thereof, wherein a first receiving space located in the upper half thereof and a second receiving space located in the lower half thereof are provided;
a liquid crystal panel disposed in the first receiving space; and
a backlight module disposed in the second receiving space.

5. The liquid crystal module according to claim 4, wherein a washer is provided between the liquid crystal panel and the backlight module.

6. The liquid crystal module according to claim 4, wherein an upper surface of the liquid crystal panel and an upper surface of the stepped frame structure are coplanar.

7. The liquid crystal module according to claim 4, wherein the liquid crystal module is further provided with a front display frame and a back display frame; the front display frame and the back display frame commonly enclose the liquid crystal module; and the shape of an inner surface of the front display frame is corresponding to the shape of an outer surface of the stepped frame structure.

8. The liquid crystal module according to claim 7, wherein the upper surface of the stepped frame structure and an upper surface of the front display frame are coplanar.

9. A stepped frame structure of a liquid crystal module, which has side edges of stepped-shape, and a lower half of which is greater than an upper half thereof, wherein a first receiving space located in the upper half thereof and a second receiving space located in the lower half thereof are provided; wherein a liquid crystal panel is disposed in the first receiving space, and a backlight module is disposed in the second receiving space.

10. The stepped frame structure of the liquid crystal module according to claim 9, wherein a washer is provided between the liquid crystal panel and the backlight module.

11. The stepped frame structure of the liquid crystal module according to claim 9, wherein an upper surface of the liquid crystal panel and an upper surface of the stepped frame structure are coplanar.

12. The stepped frame structure of the liquid crystal module according to claim 9, wherein the liquid crystal module is further provided with a front display frame and a back display frame; the front display frame and the back display frame commonly enclose the liquid crystal module; and the shape of an inner surface of the front display frame is corresponding to the shape of an outer surface of the stepped frame structure.

13. The stepped frame structure of the liquid crystal module according to claim 13, wherein the upper surface of the stepped frame structure and an upper surface of the front display frame are coplanar.
